(19) United States
(12) Patent Application Publication
(10) Pub. No.: US 2013/0324647 A1
(43) Pub. Date: Dec. 5, 2013

(54) FLAME RETARDANT POLYMER COMPOSITIONS COMPRISING STABILIZED HYPOPHOSPHITE SALTS

(71) Applicants: Floryan De Campo, Shanghai (CN); Annelyse Murillo, Shanghai (CN); Junli Li, Shanghai (CN); Tingting Zhang, Shanghai (CN)

(72) Inventors: Floryan De Campo, Shanghai (CN); Annelyse Murillo, Shanghai (CN); Junli Li, Shanghai (CN); Tingting Zhang, Shanghai (CN)

(73) Assignee: RHODIA (CHINA) CO,. LTD, Shanghai (CN)

(21) Appl. No.: 13/985,613

(22) PCT Filed: Feb. 17, 2012
(86) PCT No.: PCT/CN12/71265

§ 371 Date: Aug. 15, 2013

Related U.S. Application Data
(63) Continuation of application No. PCT/CN2011/071245, filed on Feb. 24, 2011.

(51) Int. Cl. C08K 3/32

(52) U.S. Cl. CPC C08K 3/32
USPC 524/101; 524/414; 524/139; 524/130; 524/133; 524/117; 524/145; 524/417; 524/100; 524/409; 524/405

(57) ABSTRACT

A flame retardant polymer composition is described. The composition can include at least one polymer and a hypophosphite salt, wherein the hypophosphite salt is heat stabilized so that when it is heated for 3 hours at 298° C. under a flow of argon flushing at rate 58 mL/min, it generates less than 0.5 mL of phosphine per gram of hypophosphite salt. The polymer can be an epoxy resin, a phenolic resin, an acrylonitrile-butadiene-styrene resin, a styrene-acrylonitrile resin, a mixture of high impact polystyrene and polyphenylene oxides, a styrene-butadiene rubber, a polylactic acid or a polyvinyl chloride.

### FIELD OF THE INVENTION

The instant invention relates to polymer compositions comprising hypophosphite salts as flame retardants (hereinafter also depicted as “FR”). More specifically, the invention makes use of stabilized hypophosphite salts.

### BACKGROUND OF THE INVENTION

Halogen free flame retardant additives are of increasing interest in reinforced and un-reinforced polymers, more particularly thermoplastic polymers, for their ability to provide FR properties while remaining environmentally benign. Among those halogen free flame retardants, hypophosphite salts or inorganic phosphinates are known as good FR additives for polymers. However, phosphinic acid salts may cause the degradation of the polymer to which they are added as mentioned for example in WO 2009/010812. Moreover, hypophosphite salts are known to have a tendency to generate phosphine at elevated temperatures at which they are processed, and phosphine is spontaneously flammable, highly toxic and strong irritant as mentioned for example in US 2007/0173572.

The proposed solution taught by US 2007/0173572 is to scavenge the generated phosphine by adding a phosphine suppressing additive which can be a specific polymer, an amide, imide, cyanurate, phosphazine among other products. The drawback of that method is that another additive is added to the polymer composition which can only neutralize the phosphine without preventing the generation of that phosphine.

Thus, there exists a constant need in the market of FR agents in having hypophosphites salts without the above drawbacks and that premature instability or at a much lower degree. There is a need to propose polymer compositions containing hypophosphite salts sufficiently stabilized in order not to generate a dangerous amount of phosphine.

### DETAILED DESCRIPTION OF THE INVENTION

After extensive research and development work, the Applicant has surprisingly found out and developed a stabilizing process for hypophosphite salts which can prevent or, at the very least, minimise, the formation of phosphine from hypophosphite salts, more particularly in their application as FR. The stabilized hypophosphite salts reveal especially suitable in some specific polymers, that it renders flame-retardant.

The current invention actually relates to a flame retardant (“FR”) polymer composition comprising at least one polymer and a hypophosphite salt, wherein:
the hypophosphite salt is so heat stabilized that, when it is heated during 3 hours at 298° C. under a flow of argon flushing at rate 58 mL/min, it generates less than 0.5 mL of phosphine per gram of hypophosphite salt; and
the at least one polymer is selected from the group consisting in epoxy resins; phenolic resins; acrylonitrile butadiene styrene (ABS); styrene acrilonitrile (SAN); mixtures of high impact polystyrene (HIPS) and polyphenylene ethers (such as PPO/HIPS); Styrene Butadiene rubber and lattices (SBR and SB); polylactic acid and polyvinylchloride (PVC).

The hypophosphite salt preferably includes and is advantageously a calcium hypophosphite. Whatever its exact nature, the hypophosphite salt present in the compositions of the invention is so heat stabilized that, when it is heated during 3 hours at 298° C. under a flow of argon flushing at rate 58 mL/min, it generates less than 0.5 mL of phosphine per gram of hypophosphite salt. Preferably according to this test it generates less than 0.1, more preferably less than 0.05, particularly less than preferably less than 0.02 mL of phosphine per gram of calcium hypophosphite. The heat stability of the hypophosphite salt at 298° C. may especially be tested by using a Gastec tube to detect PH3, as illustrated in the appended examples.

Generally, a flame retardant polymer composition of the invention comprises the hypophosphite salt in an amount of 0.1 to 30 weight percent, preferably from 1 to 25 weight percent, for example from 5 to 20 weight percent, based on the total weight of the flame retardant polymer composition.

Advantageously, the flame retardant polymer composition of the invention may comprise at least an additive, other than the hypophosphite salt, improving the flame retardant properties of the composition, herein called as “flame retardant additive”.

Different types of flame retardant additives may be used according to the invention. They can provide several mechanisms of function such as endothermic degradation, thermal shielding, dilution of gas phase, dilution of combustible portion, and radical quenching.

Flame retardant additives for polymer compositions are notably described in Plastics Additives, Gächter/Müller, Hansen, 1996, page 709 and passim. Useful Flame retardant additives are notably cited in the following patents: U.S. Pat. No. 6,344,158, U.S. Pat. No. 6,365,071, U.S. Pat. No. 6,211,402 et U.S. Pat. No. 6,255,371.

Flame retardant additives used in the composition of the instant invention are preferably chosen in the group comprising:
A) Phosphorous containing flame retardant additives, such as:
   phosphine oxide such as for example triphenylphosphine oxide, tri-(3-hydroxypropyl) phosphine oxide and tri-(3-hydroxy-2-methylpropyl) phosphine oxide.
   phosphonic acids and their salts, and phosphinic acids and their salts, such as for example phosphinic acid of zinc, magnesium, calcium, aluminium or manganese, notably aluminium salt of diethylphosphinic acid, aluminium salt of dimethylphosphinic acid, or zinc salt of dimethylphosphinic acid.
   cyclic phosphonates, such as diphosphate cyclic esters that is for example Antiblaze 1045.
   organic phosphates such as triphenylphosphate.
   inorganic phosphates such as ammonium polyphosphates and sodium polyphosphates.
   red phosphorous, that can may be found under several shapes such as stabilized, coated, as a powder.
B) Nitrogen containing flame retardant additives, such as: triazines, cyanuric acid and/or isocyanuric acid, melamine or its derivatives such as cyanurate, oxalate, phtalate, borate, sulfate, phosphate, polyphosphate and/or pyrophosphate, condensed products of melamine such as melem, melam, melon, tris(hydroxyethyl) isocyanurate, benzoguanamine, guanidine, allantoïne and glycoluril.
C) Halogen containing flame retardant additives, such as:
   Bromine containing flame retardant additives, such as polybromodiphenyl oxydes (PBDPO), brominated polystyrene (BrPS), poly(pentabromobenzylacrylate), brominated indane, tetradecabromodiphenoxybenzene (Saytex 120), ethane-1,2-bis(pentabromophenyl) or Saytex 8010 of Albemarle, tetrabromobisphenol A and brominated epoxy oligomers. Notably can be used the following compounds: PDBS-80 from Chemtura, Saytex HP 3010 from Albemarle or FR-803P from Dea Sea Bromine Group, FR-1210 from Dea Sea Bromine Group, octabromodiphenylether (OBPE), FR-245 from Dead Sea Bromine Group, FR-1025 from Dead Sea Bromine Group and F-2300 or F2400 from Dead Sea Bromine Group.
   Chlorine containing flame retardant additives, such as Dechlorane Plus® from OxyChem (CAS 13560-89-9).
D) Inorganic flame retardant additives, such as antimony trioxide, aluminium hydroxide, magnesium hydroxide, cerium oxide, boron containing compounds such as calcium borate.

These flame retardant additives may be used alone or in combination. Charring agents and charring catalysts may also be used if necessary.

A composition according to the present invention may comprise the heat stabilized hypophosphite salt and 1 to 20% by weight of melamine.

A composition according to the present invention may also comprise the heat stabilized hypophosphite salt and 1 to 20% by weight of melamine cyanurate.

A composition according to the present invention may comprise the heat stabilized hypophosphite salt and 1 to 20% by weight of melem.

A composition according to the present invention may comprise the heat stabilized hypophosphite salt and 1 to 20% by weight of red phosphorous, notably a masterbatch made of polymer and comprising red phosphorous.

A composition according to the present invention may comprise the heat stabilized hypophosphite salt and 1 to 20% by weight of a phosphinate salt, such as aluminium phosphinate, aluminium salt of diethylphosphinic acid and/or aluminium salt of dimethylphosphinic acid.

Hypophosphite salts may be surface coated by several compounds such as alkali-metal or alkali-earth hydrates; hydrotalcite or hydrotalcite-like compounds; and/or alkali-metal or alkali-earth organic acid salts, such as Mg(OH)2, for example. Hypophosphite salts can be preferably surface-coated by magnesium hydroxide, synthetic hydrotalcite, sodium benzoate, potassium benzoate, sodium stearate, and/or calcium stearate.

The heat stabilized hypophosphite salt which is present in the flame retardant polymer composition according to the instant invention may especially be obtained from a starting hypophosphite salt, by a process for stabilizing said hypophosphite salt, comprising the steps of:
a) washing the starting hypophosphite salt at least one time, preferably 2 or 3 times, under a controlled value of pH comprised between 4 and 11, preferably between 5 and 8, said hypophosphite salt being in an aqueous solution and/or in a solid state, and
b) drying the hypophosphite salt as obtained after the washing operation(s) of step (a) under reduced pressure to remove the volatiles.

Advantageously, the heat stabilized hypophosphite salt which is present in the flame retardant polymer composition according to the instant invention is obtained according to a process including he above step (a) and (B) and which further comprise, after step a) (and generally before step b)) the step a1) of:
a1) washing at least one time the hypophosphite salt with an organic solvent miscible with water.

The organic solvent used in step a) described above is preferably selected from the group comprising acetone, methanol, isopropanol, tetrahydrofurane, and acetonitrile.

According to a first possible embodiment, the starting hypophosphite salt which is used in step a) can be in the form of an aqueous solution, charged in a reactor and mixed with a mineral or an organic acid to obtain a slurry whose pH is set at a value of between 4 and 6.5, preferably 5 and 6.

The acid used in this connection is preferably selected from the group comprising hypophosphorous acid, citric acid, maleic acid, acetic acid, chlorhydric acid and sulphuric acid and, more preferably, the acid is hypophosphorous acid.

According to another embodiment, the starting hypophosphite salt of step a) may alternatively be in the form of an aqueous solution, charged in a reactor and mixed with a mineral or an organic base to obtain a slurry whose pH is set at a value of between 7.5 and 11, preferably 8 and 10. In that case the base is preferably selected from the group comprising sodium hydroxide, potassium hydroxide, calcium hydroxide, calcium oxide, magnesium oxide and magnesium hydroxide, even more preferably, the base is calcium hydroxide and/or calcium oxide.

According to an interesting embodiment, the starting hypophosphite salt comes from the reaction of calcium oxide, water and hypophosphorous acid.

More generally, the starting hypophosphite salt can be prepared by any manufacturing process.

The hypophosphite salts and, especially, calcium hypophosphite, can be prepared for example from white phosphorus (P₄) reacted under alkaline conditions with calcium hydroxide or calcium oxide and water as taught by U.S. Pat. No. 5,225,052.

It is also possible to obtain calcium hypophosphite by reaction of a calcium salt or simply from lime as taught by Chinese patent CN101332982, with hypophosphorous acid. For example the lime suspension is simply neutralized with hypophosphorous acid, the impurities are removed by filtration and the product isolated in a same way as previously described.

It is also possible to obtain calcium hypophosphite from other metallic hyphosphites or the acid by ion exchange process.

The process for stabilizing the starting hypophosphite salt which is useful for preparing the polymer composition of the invention can be batch, continuous or semi-continuous and be performed in a close or open system under inert atmosphere. That inert atmosphere can be for example carbon dioxide, argon, or nitrogen.

The process for stabilizing the starting hypophosphite salt can be performed under atmospheric pressure, under pressure or under vacuum.

Without linking the current invention to any theoretical rationale, it looks like most of the premature instability is due to the presence of problematic impurities. The quality of the hypophosphite salts may be determined by detecting the remaining impurities using thermal analysis tools such as ARC (Adiabatic Reaction calorimeter) and TGA (Thermal Gravimetric Analysis). The test can be carried out at any stage during the heating process described before.

Another way to check the quality of the heat stabilized hypophosphite salt used in the instant invention, is to perform a stability test at elevated temperature on the product, alone or mixed with plastic and measure the amount of phosphine generated during the test. It is also possible to measure the amount of phosphine generated when the product is compounded with plastics such as polyamide.

The hypophosphite salt present in the composition according to the invention is preferably of the formula (1) below:

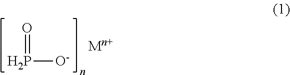

wherein:
n is 1, 2 or 3; and
M is a metal selected from the group consisting alkali metal, alkaline earth metal, aluminium, titanium and zinc. Preferably, M is calcium or aluminium.

In addition to the polymer and the heat stabilized hypophosphite salt, the compositions of the invention may further comprise fillers and reinforcing materials and/or other additives, such as lubricants (stearic acid or stearate salts such as calcium stearate) or antidriping agents such as poly(tetrafluoroethylene) (such as PTFE SN3306 for example).

More generally, the composition according to the invention may also comprise additives normally used for the manufacture of polymer compositions, especially intended to be molded. Thus, mention may be include plasticizers, nucleating agents, catalysts, light and/or thermal stabilizers, antioxidants, antistatic agents, colorants, pigments, matting agents, conductive agents, such as carbon black, molding additives or other conventional additives.

For the preparation of a polymer composition, the fillers and additives may be added to by any conventional means suitable, for instance during the polymerization or as a molten mixture. The additives are preferably added to the polymer in a melt process, in particular during a step of extrusion, or in a solid process in a mechanical mixer; the solid mixture may then be melted, for example by means of an extrusion process.

The compositions according to the invention may be used as raw material in the field of plastics processing, for example for the preparation of articles formed by injection-molding, by injection/blow-molding, by extrusion or by extrusion/blow-molding. According to one customary embodiment, the modified polyamide is extruded in the form of rods, for example in a twin-screw extrusion device, said rods then being chopped into granules. The molded components are then prepared by melting the granules produced above and feeding the molten composition into injection-molding devices.

As articles obtained from the composition according to the invention mention may, for example, be made of articles in the motor vehicle industry, such as components under the engine hood, bodywork components, tubes and tanks, or articles in the electrical and electronics field, such as connecters.

The invention will now be further illustrated by the following examples that refers to two distinct hypophosphite salts, namely:
CaHypo COM:
calcium hypophosphite made from the commercial grade of calcium hypophosphite sourced from Shanghai lingfeng chemical reagent co., ltd.
CaHypo HT:
calcium hypophosphite so-called ‘High Temperature’ or ‘HT’, namely heat stabilized calcium hypophosphite according to the invention

### Example 1

CaHypo COM (102 g) is charged in a reactor and mixed with water (161 g). 50% hypophosphorous acid (34 g) is then added slowly and the mixture is thoroughly stirred for 30 minutes and the pH is controlled between 4 and 6. Then, the slurry is filtered to afford 75 g of solid. This solid is washed with water (40 g) and then with acetone (75 g). 57.8 g of wet solid is thus obtained to finally afford 56 g of dry CaHypo-HT after evaporation of the volatiles under reduced pressure overnight at room temperature.

### Example 2

### Thermal Aging Test

2 g of CaHypo COM and CaHypo HT (from Example 1) are weighed and placed in separate glass vials. The vials are then placed into an oven pre-heated to 290° C. under air. Pictures of the samples are then taken over time to compare the change of color. The pictures obtained, shown below, clearly indicate that CaHypo HT does not change color as quickly as the regular CaHypo commercial grade. The CaHypo COM material starts yellowing significantly between 1 to 5 h while the CaHypo HT did not yellow before 8 h. The yellowing of CaHypo is typically due to the formation of red phosphorus which is itself associated with the formation of phosphine.

The results are gathered in table 1 below:

TABLE 1

| Time | 0 h | 1 h | 5 h | 8 h | 15 h |
|---|---|---|---|---|---|
| Non-treated | White | White | Pale | Yellow | Dark |
| CaHypo | | | yellow | | yellow/orange |
| Stabilized | White | White | White | Pale | yellowish |
| CaHypo | | | | yellow | |

### Example 3

### Phosphine Generation—Scrubber Detection

For this experiment 2 g of CaHypo (COM or HT from Example 1) are heated to 300° C. for 30 minutes under a flow of argon. The out gases are bubbled through a 5% hydrogen peroxide solution to scrub phosphine that may be generated. The scrubber solution is then analyzed by Ion Chromatography (IC) to determine the level of phosphate. The phosphine generated is then calculated by assuming that all the phosphate detected is issued from phosphine. For CaHypo COM, a total of 555.8 ppm of phosphine/g of CaHypo is detected while only 235 ppm of phosphine/g of CaHypo is detected for CaHypo HT. Overall, under these conditions the amount of phosphine generated by CaHypo HT is reduced by about 60% compared to the commercial product.

### Example 4

For this experiment 2 g of CaHypo (COM or HT from Example 1) are heated to 298° C. under a flow of argon. The out gases are captured into gas bags and the concentration of phosphine is measured over time using Gastec tubes. The results (Table 2) clearly indicate that the amount of phosphine generated with CaHypo HT is up to 34 times lower which corresponds to a 97% reduction of the amount of phosphine generated compared to commercial CaHypo.

TABLE 2
Phosphine generation

Total Phosphine generated (mL)
for 2 g of CaHypo

| Time | CaHypo COM | CaHypo-HT (Example 1) |
|---|---|---|
| 0.5 h | 0.17 | 0.01 |
| 1.5 h | 0.79 | 0.02 |
| 3.0 h | 2.15 | 0.06 |

2 g sample heated to 298° C. with argon flushing at rate 58 mL/mins

### Example 5

### Water Wash

CaHypo COM (275 g) is charged in 1 L plastic bottle and mixed with water (119 g) as well as ceramic balls (293 g). The resulting mixture is rotated for 4 h and the pH is controlled between 4-6. Then the balls are separated with wired filter. The white solid is washed with water (40 g) and then three times with acetone to afford 242 g of wet CaHypo-HT. The final product is dried under reduced pressure at room temperature to remove any volatile and afforded 240 g of product.

### Example 6

### Phosphine Generation Measuring PH₃ in Gas

For this experiment 2 g of CaHypo (COM or HT from Example 5) are heated to 298° C. under a flow of argon. The out gases are captured into gas bags and the concentration of phosphine is measured over time using Gastec tubes. The results (Table 3) clearly indicated that the amount of phosphine generated with CaHypo HT is up to 140 times lower which corresponded to a 99.3% reduction of the amount of phosphine generated compared to commercial CaHypo.

TABLE 3
Phosphine Generation

Total Phosphine generated (mL)

| Time | CaHypo COM | CaHypo-HT (Example 5) |
|---|---|---|
| 0.5 h | 0.36 | 0.01 |
| 1.5 h | 2.12 | 0.02 |
| 3.0 h | 4.24 | 0.03 |

2 g sample heated to 298° C. with argon flushing at rate 58 mL/mins.

### Example 7

### Phosphine generation measuring PH₃ in Gas—CaHypo+PA 6,6

In this experiment, 6 g of PA6,6 are charged in a glass tube and heated to 298° C. for 3 h flushing with argon. Then 2 g of CaHypo (COM or HT from Example 5) are added. After that, the out gases are captured into gas bags and the concentration of phosphine is measured over time using Gastec tubes. The results (Table 4) clearly indicate that the amount of phosphine generated with CaHypo HT is up to 74 times lower which corresponds to a 98.7% reduction of the amount of phosphine generated compared to the commercial CaHypo.

TABLE 4
Phosphine generation with PA 6,6

Total Phosphine generated (mL)

| Time | CaHypo COM | CaHypo-HT (Example 5) |
|---|---|---|
| 0.5 h | 0.18 | 0.02 |
| 1.5 h | 1.06 | 0.05 |
| 3.0 h | 7.42 | 0.10 |

2 g sample + 6 g PA 6,6 heated to 298° C. with argon flushing at rate 58 mL/mins.

### Example 8

### Preparation of CaHypo-HT from CaO and HPA

Calcium oxide (39.2 g, 0.7 mol) is mixed with water (398 g) under inert atmosphere. 50% hypophosphorous acid (129 g, 0.98 mol) is added slowly at room temperature while the pH is monitored. The pH is adjusted to 5-7 and the solution boiled for 3 h. Then, the mixture is cooled down and a portion of it filtered to obtain 284 g. This filtrate is pH adjusted to 6.5-7 and water is distilled off under reduced pressure to afford 252 g of distillate. After cooling down the solution is filtered to afford 8.6 g of CaHypo-HT. The product is dried under vacuum at 90° C. overnight.

The product thus obtained is tested for phosphine generation by heating 2 g of material to 298° C. under argon while analyzing the off-gases for phosphine. The results indicated that after 30 minutes the total amount of phosphine generated is as low as 0.007 mL which is 51 times lower that the amount detected for CaHypo COM in the same conditions. Overall, the phosphine generation is reduced by 98.1% compared to commercial CaHypo.

### Example 9

### Recrystallization Treatment

CaHypo COM (418 g) is dissolved in water (3012 g) under inert atmosphere and heated to reflux. The pH of the solution is adjusted to 9-10 using lime and the mixture refluxed for 2 h. After cooling down to room temperature the solution is filtered. The filtrate is then pH adjusted to between 6 and 7 using 50% hypophosphorous acid and then filtered again. The resulting solution is concentrated under reduced pressure until CaHypo precipitated. The solid thus obtained is filtered out at room temperature to afford 307 g of wet material. After drying the product under reduced pressure at 120° C. for 6 h 297 g of product is in hand.

### Example 10

### Phosphine Generation Measuring PH₃ in Gas

For this experiment 2 g of CaHypo (COM or HT from Example 9) are heated to 298° C. under a flow of argon. The out gases are captured into gas bags and the concentration of phosphine is measured over time using Gastec tubes. The results (Table 5) clearly indicate that the amount of phosphine generated with CaHypo HT is up to 70 times lower which corresponds to a 98.6% reduction of the amount of phosphine generated compared to the commercial CaHypo.

TABLE 5
Phosphine generation

Total Phosphine generated (mL)

| Time | CaHypo COM | CaHypo-HT (Example 10) |
|---|---|---|
| 0.5 h | 0.36 | 0.01 |
| 1.5 h | 2.12 | 0.04 |
| 3.0 h | 4.24 | 0.06 |

2 g sample heated to 298° C. with argon flushing at rate 58 mL/mins.

### Example 11

### Phosphine Generation Measuring PH₃ in Gas—Grinded Sample

CaHypo HT obtained in Example 9 is found to have a particle size superior to 100 microns. Some of this product is grinded using wet ball milling to reach a particle size inferior to 50 microns. The material thus obtained is then tested for phosphine evolution by heating 2 g to 298° C. under argon and by analyzing the off-gases for phosphine. The results are summarized in Table 6 and compared to the results obtained with CaHypo COM in the same conditions. The amount of phosphine generated is 35 times lower with CaHypo HT which corresponded to 97.3% reduction compared to the commercial product. This experiment shows that adjusting the particle size of CaHypo HT does not alter its performance.

TABLE 6
Phosphine generation

Total Phosphine generated (mL)

| Time | CaHypo COM | CaHypo-HT (Example 11) |
|---|---|---|
| 0.5 h | 0.36 | 0.02 |
| 1.5 h | 2.12 | 0.05 |
| 3.0 h | 4.24 | 0.12 |

2 g sample heated to 298° C. with argon flushing at rate 58 mL/mins.

### Example 12

### Compounding and Injection Molding of CaHypo HT

A sample of Example 11 (ground CaHypo HT) has been tested on an extruder and injection molding machine to verify that it is safe to compound. The product is compounded as indicated in the table below with a maximum processing temperature of 270° C. The formulations have been tested, and in all cases, the extrusion went well without any issues.

During the experiment, the out gases are captured into gas bags and the concentration of phosphine is measured over time using Gastec tubes. When samples of vent gases are analyzed no phosphine could be detected indicating that the level of phosphine is inferior to 0.05 ppm.

The formulations have then the formulations have then been injected into molded to prepare 0.8 mm and 1.6 mm specimens with a temperature of 270° C. The phosphine is also measured during this process and found to be inferior to 0.05 ppm.

The results are reported in the table 6 below, wherein the ratio of the compounds are expressed in parts by weight.

TABLE 6
Compounding using CaHypo HT

| | | | | | | | | |
|---|---|---|---|---|---|---|---|---|
| HIPS | 75 | 80 | 70 | 75 | 80 | 75 | | 53 |
| 8250 | | | | | | | | |
| ABS | | | | | | | 72 | |
| 121H | | | | | | | | |
| PPO | | | | | | | | 20 |
| CaHyPo | 25 | 20 | 15 | 15 | 15 | 10 | 22 | 5 |
| HT | | | | | | | | |
| MCA | | | 15 | | | | | 7 |
| (NH₄)₃PO₄ | | | | 10 | | | | |
| Antiblaze | | | | | 5 | | | |
| 1045 | | | | | | | | |
| Mg(OH)₂ | | | | | | 10 | | |
| ATO | | | | | | | 6 | |
| Extrusion | OK | OK | OK | OK | | | OK | OK |
| Injection | OK | OK | OK | OK | | | OK | OK |
| UL94 | V2 | V2 | V2 | V2 | | | V0 | V0 |
| 1.6 mm | | | | | | | | |

### Example 13

### Compounding CaHypo HT and PLA

A sample of Example 11 (ground CaHypo HT) has been compounded with a polylactic acid resin and tested on an extruder and injection molding machine. The formulations have been tested, and in all cases, the extrusion went well without any issues.

During the experiment, the out gases are captured into gas bags and the concentration of phosphine is measured over time using Gastec tubes. When samples of vent gases are analyzed no phosphine could be detected indicating that the level of phosphine is inferior to 0.05 ppm.

The formulations have then the formulations have then been injected into molded to prepare 1.6 mm specimens. The phosphine is also measured during this process and found to be inferior to 0.05 ppm.

The results are reported in the table 7 below, wherein the ratio of the compounds are expressed in parts by weight.

TABLE 7
Compounding using CaHypo HT

| | | |
|---|---|---|
| PLA | 90% | 85% |
| CaHyPo HT | 10% | 15% |
| Extrusion: 175~180° C. | OK | OK |
| Injection: 190° C. | OK | OK |
| UL94 1.6 mm | V0 | V0 |

1. A flame retardant polymer composition comprising at least one polymer and a hypophosphite salt, wherein:
the hypophosphite salt is heat stabilized so that, when it is heated during 3 hours at 298° C. under a flow of argon flushing at rate 58 mL/min, it generates less than 0.5 mL of phosphine per gram of hypophosphite salt; and
the at least one polymer is selected from the group consisting of epoxy resins; phenolic resins; acrylonitrile butadiene styrene (ABS); styrene acrilonitrile (SAN);
mixtures of high impact polystyrene (HIPS) and polyphenylene ethers; Styrene Butadiene rubber and lattices (SBR and SB); and polylactic acid and polyvinylchloride (PVC).

2. (canceled)

3. The flame retardant polymer composition as defined by claim 1, wherein the hypophosphite salt is calcium hypophosphite.

4. The flame retardant polymer composition as defined by claim 1, wherein the hypophosphite salt is present in an amount of 0.1 to 30 weight percent, based on the total weight of the flame retardant polymer composition.

5. The flame retardant polymer composition as defined by claim 1, which further comprises at least one additive, other than the hypophosphite salt, that improves flame retardant properties of the composition, wherein the at least one additive is selected from the group consisting of:
A) phosphorous containing flame retardant additives;
B) nitrogen containing flame retardant additives;
C) halogen containing flame retardant additives;
D) inorganic flame retardant additives.

6. The flame retardant polymer composition as defined by claim 1, wherein the heat stabilized hypophosphite salt is obtained from a starting hypophosphite salt, by a process for stabilizing said starting hypophosphite salt, the process comprising the steps of:
a) washing a starting hypophosphite salt at least one time under a controlled value of pH of between 4 and 11 said hypophosphite salt being in an aqueous solution and/or in a solid state, and
b) drying the hypophosphite salt as obtained after the washing operation(s) of step (a) under reduced pressure to remove volatiles.

7. The flame retardant polymer composition as defined by claim 6, wherein the starting hypophosphite salt of step a) is in the form of an aqueous solution, charged in a reactor and mixed with a mineral or an organic acid to obtain a slurry whose pH is set at a value of between 4 and 6.5.

8. The flame retardant polymer composition as defined by claim 6, wherein the starting hypophosphite salt of step a) is in the form of an aqueous solution, charged in reactor and mixed with a mineral or an organic base to obtain a slurry whose pH is set at a value of between 7.5 and 11.

9. The flame retardant polymer composition as defined by claim 6, wherein the starting hypophosphite salt comes from the reaction of calcium oxide, water and hypophosphorous acid.

10. The flame retardant polymer composition as defined by claim 1, wherein the hypophosphite salt is of the formula (1): 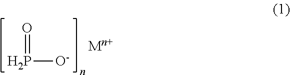
wherein n is 1, 2 or 3, and
M is a metal selected from the group consisting alkali metal, alkaline earth metal, aluminum, titanium and zinc.

11. The flame retardant polymer composition as defined by claim 1, wherein the mixture of the high impact polystyrene (HIPS) and the polyphenylene is PPO/HIPS.

12. The flame retardant polymer composition as defined by claim 5, wherein the phosphorous containing flame retardant additive is selected from the group consisting of phosphine oxide, phosphonic acids and their salts, phosphinic acids and their salts, cyclic phosphonates, organic phosphates, inorganic phosphates and red phosphorous.

13. The flame retardant polymer composition as defined by claim 5, wherein the nitrogen containing flame retardant additive is selected from the group consisting of triazines, cyanuric acid and/or isocyanuric acid and melamine.

14. The flame retardant polymer composition as defined by claim 5, wherein the halogen containing flame retardant additive is selected from the group consisting of bromine containing flame retardant additives and chlorine containing flame retardant additives.

15. The flame retardant polymer composition as defined by claim 5, wherein the inorganic flame retardant additive is selected from the group consisting of antimony trioxide, aluminum hydroxide, magnesium hydroxide, cerium oxide and boron containing compounds.

16. The flame retardant polymer composition as defined by claim 15, wherein the boron containing compound is calcium borate.

17. The flame retardant polymer composition as defined by claim 6, wherein the washing step (a) comprising washing the starting hypophosphite salt two or three times.

18. The flame retardant polymer composition as defined by claim 6, wherein the washing step (a) is conducted under a controlled pH value of between 5 and 8.

19. The flame retardant polymer composition as defined by claim 7, wherein the pH value of the slurry is at a value between 5 and 6.

20. The flame retardant polymer composition as defined by claim 7, wherein the acid is selected from the group consisting of hypophosphorous acid, citric acid, maleic acid, acetic acid, chlorhydric acid and sulphuric acid.

21. The flame retardant polymer composition as defined by claim 7, wherein the acid is hypophosphorous acid.

22. The flame retardant polymer composition as defined by claim 8, wherein the pH of the slurry is set at a value between 8 and 10.

23. The flame retardant polymer composition as defined by claim 8, wherein the base is selected from the group consisting of sodium hydroxide, potassium hydroxide, calcium hydroxide, calcium oxide, magnesium oxide and magnesium hydroxide.

24. The flame retardant polymer composition as defined by claim 8, wherein the base is calcium hydroxide or calcium oxide.

25. The flame retardant polymer composition as defined by claim 10, wherein the metal M is calcium or aluminum.
